(19) United States
(12) Patent Application Publication
(10) Pub. No.: US 2025/0300714 A1
(43) Pub. Date: Sep. 25, 2025

(54) METHODS, ARCHITECTURES, APPARATUSES AND SYSTEMS FOR PRECODING DETERMINATION

(71) Applicant: InterDigital Patent Holdings, Inc., Wilmington, DE (US)

(72) Inventors: Loic Canonne-Velasquez, Dorval (CA); Afshin Haghighat, Ile-Bizard (CA); Moon IL Lee, Melville, NY (US); Jonghyun Park, Syosset, NY (US); Virgil Comsa, Montreal (CA)

(21) Appl. No.: 18/615,061

(22) Filed: Mar. 25, 2024

(51) Int. Cl. H04B 7/06; H04B 7/0404

(52) U.S. Cl. CPC H04B 7/0691; H04B 7/0404

(57) ABSTRACT

Procedures, methods, architectures, apparatuses, systems, devices, and computer program products using wireless transmit/receive unit (WTRU) configured for sending first information indicating a set of one or more antenna port groups, wherein each antenna port group, of the set of one or more antenna port groups, is associated with at least one transmit antenna of the WTRU; receiving second information indicating at least one set of precoders; receiving third information indicating a precoder of the at least one set of precoders, a scaling value, and a phase value; and sending via at least one transmit antenna element associated with the at least one antenna port group, a transmission having at least one symbol based on the precoder, the scaling value associated with the at least one antenna port group and the phase value associated with the at least one antenna port group.

### BACKGROUND

The present disclosure is generally directed to the fields of communications, software and encoding, including, for example, to methods, architectures, apparatuses, systems directed to precoding determination, for example to methods, apparatus and systems using precoding determination for 3 transmit antennas.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a configuration of co- and cross-polarized antennas;

FIG. 3 illustrates an example of a WTRU (e.g., UE) antenna port groups with different capability groups;

FIG. 4 illustrates a representative procedure for precoding determination; and

FIG. 5 is a flow chart illustrating example flow.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Provided below are acronyms/abbreviations for terms and phrases commonly used in this application:

| | |
|---|---|
| ACK | Acknowledgement |
| AP | Antenna Port |
| APG | Antenna Port Group |
| BWP | Bandwidth Part |
| CCE | Control Channel Element |
| CE | Control Element |
| CG | Configured grant |
| CP | Cyclic Prefix |
| CP-OFDM | Conventional OFDM (relying on cyclic prefix) |
| CQI | Channel Quality Indicator |
| CRC | Cyclic Redundancy Check |
| CSI | Channel State Information |
| DCI | Downlink Control Information |
| DG | Dynamic grant |
| DL | Downlink |
| DMRS | Demodulation Reference Signal |
| HARQ | Hybrid Automatic Repeat Request |
| LTE | Long Term Evolution, e.g., from 3GPP LTE R8 and up |
| MCS | Modulation and Coding Scheme |
| MIMO | Multiple Input Multiple Output |
| NACK | Negative ACK |
| NR | New Radio |
| OFDM | Orthogonal Frequency-Division Multiplexing |
| PHY | Physical Layer |
| PUSCH | Physical Uplink Shared Channel |
| PSS | Primary Synchronization Signal |
| RA | Random Access (or procedure) |
| RACH | Random Access Channel |
| RAR | Random Access Response |
| RCU | Radio access network Central Unit |
| RF | Radio Front end |
| RNTI | Radio Network Identifier |
| RO | RACH occasion |
| RRC | Radio Resource Control |
| RRM | Radio Resource Management |
| RS | Reference Signal |
| RSRP | Reference Signal Received Power |
| RSSI | Received Signal Strength Indicator |
| SDU | Service Data Unit |
| SRS | Sounding Reference Signal |
| SRI | SRS Resource Set Indicator |
| SS | Synchronization Signal |
| SSS | Secondary Synchronization Signal |
| SPS | Semi-persistent scheduling |
| SUL | Supplemental Uplink |
| TB | Transport Block |
| TBS | Transport Block Size |
| TDM | Time Division Multiplex |
| TPMI | Transmit Precoding Matrix Indication |
| TRP | Transmission/Reception Point |
| UL | Uplink |
| URLLC | Ultra-Reliable and Low Latency Communications |

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

Herein, the terms prediction and estimation may be used interchangeably, but still consistent with the following description.

Herein, the terms candidate cell, neighbor cell, and target cell may be used interchangeably, but still consistent with the following description.

Herein, the terms source cell, current cell, and serving cell may be used interchangeably, but still consistent with the following description.

### Example Communications System

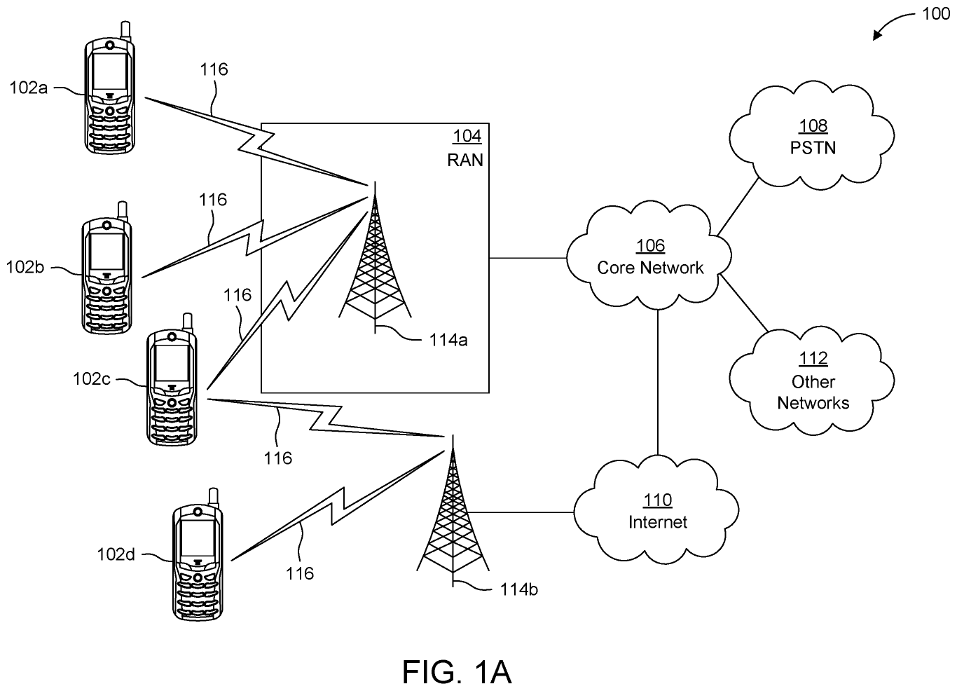

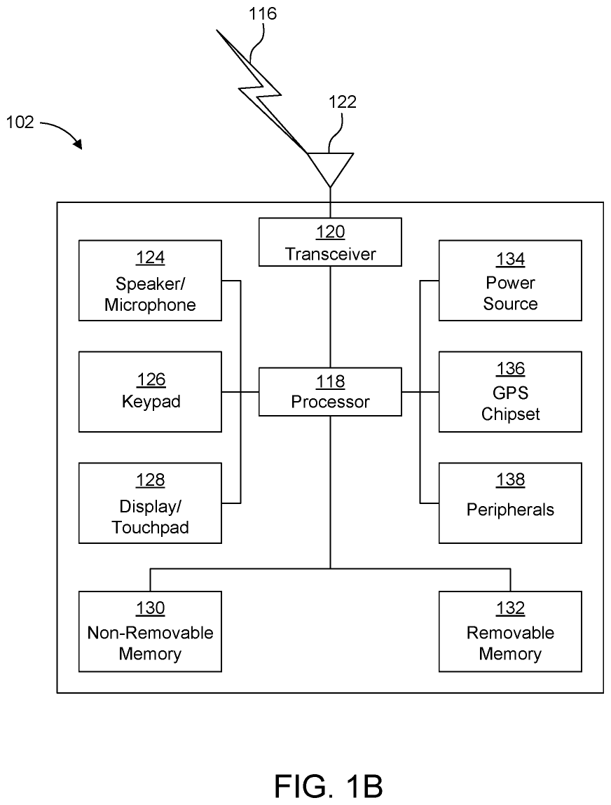

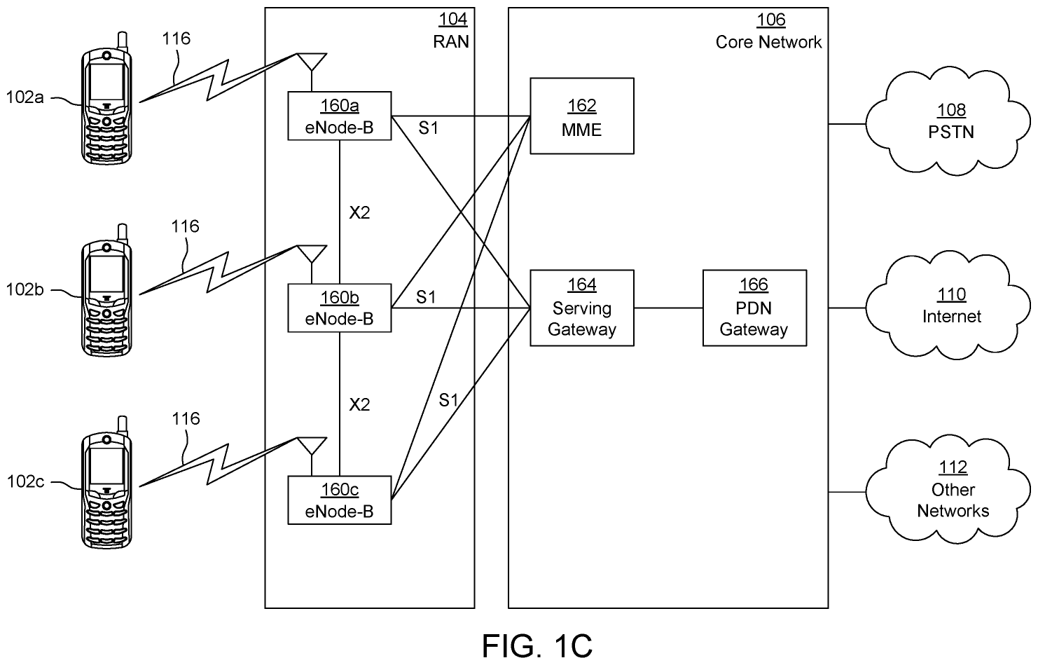

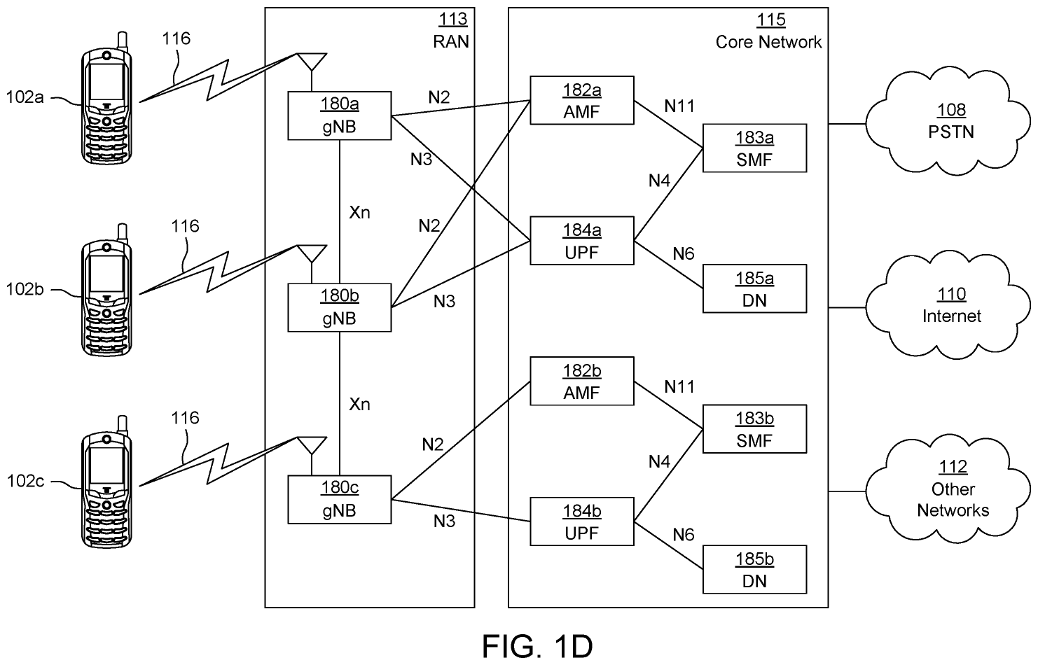

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHz, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

A WTRU (e.g., UE) may transmit or receive a physical channel or reference signal according to at least one spatial domain filter. The term “beam” may be used to refer to a spatial domain filter.

The WTRU (e.g., UE) may transmit a physical channel or signal using the same spatial domain filter as the spatial domain filter used for receiving an RS (such as CSI-RS) or a SS block. The WTRU (e.g., UE) transmission may be referred to as “target”, and the received RS or SS block may be referred to as “reference” or “source”. In such case, the WTRU (e.g., UE) may be said to transmit the target physical channel or signal according to a spatial relation with a reference to such RS or SS block.

The WTRU (e.g., UE) may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU (e.g., UE) may be said to transmit the first (target) physical channel or signal according to a spatial relation with a reference to the second (reference) physical channel or signal.

A spatial relation may be implicit, configured by RRC or signaled by MAC CE or DCI. For example, a WTRU (e.g., UE) may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU (e.g., UE) may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU (e.g., UE) is configured with a quasi-colocation (QCL) assumption type D between corresponding antenna ports. Such association may be configured as a transmission configuration indicator (TCI) state. A WTRU (e.g., UE) may be indicated an association between a CSI-RS or SS block and a DM-RS by an index to a set of TCI states configured by RRC and/or signaled by MAC CE. Such indication may also be referred to as a “beam indication”.

Hereafter, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with the following description. Hereafter, multi-TRP may be interchangeably used with one or more of MTRP, M-TRP, and multiple TRPs, but still consistent with the following description.

A WTRU (e.g., UE) may be configured with (or may receive information indicating a configuration of) one or more TRPs to which the WTRU (e.g., UE) may transmit and/or from which the WTRU (e.g., UE) may receive. The WTRU (e.g., UE) may be configured with one or more TRPs for one or more cells. A cell may be a serving cell, secondary cell.

A WTRU (e.g., UE) may be configured with at least one RS for the purpose of channel measurement. This RS may be denoted as a Channel Measurement Resource (CMR) and may comprise a CSI-RS, SSB, or other downlink RS transmitted from the TRP to a WTRU (e.g., UE). A CMR may be configured or associated with a TCI state. A WTRU (e.g., UE) may be configured with a CMR group where CMRs transmitted from the same TRP may be configured. Each group may be identified by a CMR group index (e.g., group 1). A WTRU (e.g., UE) may be configured with one CMR group per TRP, and the WTRU (e.g., UE) may receive a linkage between one CMR group index and another CMR group index, or between one RS index from one CMR group and another RS index from another group.

A WTRU (e.g., UE) may be configured with (or receive information indicating a configuration of) one or more pathloss (PL) reference groups (e.g., sets) and/or one or more SRS groups, SRS resource indicator (SRI) or SRS resource sets.

A PL reference group may correspond to or may be associated with a TRP. A PL reference group may include, identify, correspond to or be associated with one or more TCI states, SRIs, reference signal sets (e.g., CSI-RS set, SRI sets), CORESET index, and or reference signals (e.g., CSI-RS, SSB).

A WTRU (e.g., UE) may receive information indicating a configuration (e.g., any configuration described herein). The configuration may be received from a gNB or TRP. For example, the WTRU (e.g., UE) may receive configuration of one or more TRPs, one or more PL reference groups and/or one or more SRI sets. A WTRU (e.g., UE) may implicitly determine an association between a RS set/group and a TRP. E.g., if the WTRU (e.g., UE) is configured with two SRS resource sets, then the WTRU (e.g., UE) may determine to transmit to TRP1 with SRS in the first resource set, and to TRP2 with SRS in the second resource set. The configuration may be via RRC signaling.

In the examples and embodiments described herein, TRP, PL reference group, SRI group, and SRI set may be used interchangeably. The terms set and group may be used interchangeably herein.

In the following description, a property of a grant or assignment may comprise any of the following parameters: (i) a frequency allocation; (ii) an aspect of time allocation, such as a duration; (iii) a priority; (iv) a modulation and coding scheme; (v) a transport block size; (vi) a number of spatial layers; (vii) a number of transport blocks; (viii) a TCI state, CRI or SRI; (ix) a number of repetitions; (x) whether the repetition scheme is Type A or Type B; (xi) whether the grant is a configured grant type 1, type 2 or a dynamic grant; (xii) whether the assignment is a dynamic assignment or a semi-persistent scheduling (configured) assignment; (xiii) a configured grant index or a semi-persistent assignment index; (xiv) a periodicity of a configured grant or assignment; (xv) a channel access priority class (CAPC); and (xvi) any parameter provided in a DCI, by MAC or by RRC for the scheduling the grant or assignment.

In the following description, an indication by DCI may comprise any of the following: (1) an (e.g., explicit) indication by a DCI field or by RNTI used to mask CRC of the PDCCH; and (2) an (e.g., implicit) indication by a property such as DCI format, DCI size, Coreset or search space, Aggregation Level, first resource element of the received DCI (e.g., index of first Control Channel Element), where the mapping between the property and the value may be signaled by RRC or MAC.

Hereafter, downlink reception may be used interchangeably with Rx occasion, PDCCH, PDSCH, SSB reception, but still consistent with the following description.

Hereafter, uplink transmission may be used interchangeably with Tx occasion, PUCCH, PUSCH, PRACH, SRS transmission, but still consistent with the following description.

Hereafter, RS may be interchangeably used with one or more of RS resource, RS resource set, RS port and RS port group, but still consistent with the following description.

Hereafter, RS may be interchangeably used with one or more of SSB, CSI-RS, SRS and DM-RS, but still consistent with the following description.

Hereafter, time instance may be interchangeably used with slot, symbol, subframe, but still consistent with the following description.

Herein, the terms power scaling and scaling may be used interchangeably, but still consistent with the following description. Power scaling may be considered as an embodiment (e.g., one of a number of different types) of scaling, for example.

Herein, the terms co-phasing and phasing, and/or co-phase and phase may be used interchangeably, but still consistent with the following description. Co-phasing may be considered as an embodiment (e.g., one of a number of different types) of phasing, for example.

In the following description, the term antenna port is used to represent a transmission/transmit antenna used for UL transmission of a signal at the WTRU (e.g., UE). The WTRU (e.g., UE) may use antenna ports to transmit reference signals (e.g., SRS or DMRS), or for transmitting physical channels (e.g., PUCCH, PUSCH). The WTRU (e.g., UE) may be equipped with multiple antenna elements. An antenna port may represent one or multiple antenna elements. An antenna port group (APG) may represent a grouping of one or more antenna ports.

In the following description, an SRS port is specified in NR, and maps to a physical time/frequency resource. In NR, the WTRU (e.g., UE) is configured with a number of SRS ports equal to the number of antenna ports reported by the WTRU (e.g., UE) in its capability. The SRS ports are used by the WTRU (e.g., UE) to transmit pilot sequences (e.g., reference signals) to a cell on preconfigured time/frequency resources.

In NR, codebook-based PUSCH is an UL transmission mode that is scheduled by the network. The WTRU (e.g., UE) receives an RRC configured set of codebooks. Each codebook is defined for the number of transmit antennas and number of layers. The codebook consists of a set of precoders, where each precoder is a matrix with the number of rows equal to the number of antennas, and number of columns equal to the number of layers. For a given number of layers and antennas, a precoder in the codebook is identified by its Transmit Precoding Matrix Indicator (TPMI). Each value in the matrix is a complex number which indicates an amplitude and phase shift that the WTRU (e.g., UE) applies per transmitted symbol. In multi-layer transmission, the symbols from different layers are linearly combined using each row of the precoding matrix before being mapped to a transmit antenna.

The WTRU (e.g., UE) is scheduled with a grant (e.g., a DCI) which includes a bit field for the precoding information and number of layers. The WTRU (e.g., UE) determines the TPMI and the number of layers of its channel (e.g., PUSCH) transmission as a function of the precoding information. The bit field is configured according to the WTRU (e.g., UE) reported capability (E.g., number of antennas, coherence assumption). Each bit field maps to an index of a precoder from the set of codebooks.

Table 1 (from reference [2]) illustrates an exemplary RRC configuration of precoding information bit field mapping to the index of a precoder from the set of codebooks for 4TX antennas and 1-4 layers.

TABLE 1

| Bit field | | Bit field | | Bit field | |
|---|---|---|---|---|---|
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| 11 | 4 layers: TPMI = 0 | 11 | 4 layers: TPMI = 0 | 11 | 4 layers: TPMI = 0 |
| 12 | 1 layer: TPMI = 4 | 12 | 1 layer: TPMI = 4 | 12-15 | reserved |
| . . . | . . . | . . . | . . . | | |

Tables 2a-d (from reference [3]) illustrate a set of codebooks for 4TX antennas with 1, 2, 3, 4 layers, respectively. Only a subset of precoders from the codebooks are shown here.

TABLE 2a

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |

TABLE 2b

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |

TABLE 2c

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |

TABLE 2d

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |

Uplink transmission on 3 antennas is a topic up for discussion in Rel-19 MIMO WID (see reference [1]). An objective may be to improve uplink throughput by specifying codebook-based transmission with 3TX at the WTRU (e.g., UE) side.

Current devices are mostly limited to 2TX, for example, because of the device size restrictions for mobile WTRUs (e.g., UEs). The throughput gain from 4Tx may be rarely realized in practice. 3 TX may represent a viable value proposition considering current technology and consumer demands. In Rel-19, the intention is to specify 3TX for the restricted case of codebook-based transmission without Full Power Transmission (FPTX), and without introducing any enhancements to the SRS resources.

3TX may improve the throughput compared to a 2TX device and may be more feasible to implement and/or deploy on mobile devices with the current state of technology compared to 4TX. The specification (e.g., only) supports 2, 4, and 8 TX implementations for codebook-based transmission, and may not support WTRUs (e.g., UEs) with 3TX. For Rel-19, the scope restricts SRS resource enhancements, so no specification may be expected for a new 3 port SRS resource. To enable this, the network may use (e.g., require) any of: (1) a procedure for sounding the channel over the 3TX reusing existing SRS resources (e.g., 1, 2, 4, 8 port SRS); (2) a codebook of precoders for 3TX which the receiver may use to determine the optimal precoder, for example, based on the sounding procedure; and (3) a method for the network to indicate to the WTRU (e.g., UE) the determined precoder for the UL codebook-based transmission.

Different WTRU (e.g., UE) implementations for 3TX may result in different capabilities amongst the 3TX antennas which may be identified by different port groups (e.g., with same polarization, same location at the WTRU (e.g., UE), same panel). The precoder may use (e.g., require) dynamic adjustments to the precoders per antenna group since different antenna port groups may experience different channel conditions.

Methods and apparatus to determine the precoder for 3TX codebook-based transmission, for example with dynamic adjustments per antenna port group, are provided.

According to embodiments, the WTRU (e.g., UE) may indicate the association of its antennas to port groups, for example, in its capability report. The antenna port group indices may be defined by antennas with same polarization, same location at the WTRU (e.g., UE), same panel, same coherent state. In a case with 3TX, the WTRU (e.g., UE) may report either a single antenna port group with 3TX, two antenna port groups with 2TX and 1TX antenna, or three antenna port groups with 1 TX.

According to embodiments, the WTRU (e.g., UE) may be configured with an SRS resource with an association of SRS ports to antenna port groups. The WTRU (e.g., UE) may transmit information indicating the SRS with all 3 antennas with the port groups mapped to antennas, and the port groups mapped to the SRS ports. The network may estimate the UL channel over the antenna port groups.

According to embodiments, the WTRU (e.g., UE) may be configured with codebooks of precoders for 3TX and 2TX antennas. The WTRU (e.g., UE) may receive information indicating a configuration of TPMIs, power scaling value (a), a co-phasing value (q). One or more (e.g., each) TPMI may indicate the precoder index from the codebooks of precoders. The WTRU (e.g., UE) may be configured with a precoding indicator bit field where each bit field maps to one TPMI. The WTRU (e.g., UE) may indicate an association between an antenna port group with an α and φ.

According to embodiments, if the WTRU (e.g., UE) receive information indicating a 3TX port precoder (e.g., a precoder for 3TX), the WTRU (e.g., UE) may determine the precoder and the α and φ values applied per antenna port group. For example, a first precoding indicator may indicate a TPMI with an α1 and φ1 applied to the first antenna port group, and a second precoding indicator may indicate a TPMI with α2 and φ2 applied to the second antenna port group.

According to embodiments, if the WTRU (e.g., UE) receive information indicating a 2TX port precoder, the WTRU (e.g., UE) may determine it is in a fallback mode.

According to embodiments, if the WTRU (e.g., UE) reported an antenna port group with 2TX, the WTRU (e.g., UE) may fall back to the antenna port group with 2TX, and may apply the 2TX precoder over it. The WTRU (e.g., UE) may apply the α and φ on the port indices within the antenna port group.

According to embodiments, if the WTRU (e.g., UE) does not report an antenna port group with 2TX, the WTRU (e.g., UE) may (e.g., dynamically) determine the 2TX ports from the 3TX based on the precoding indicator. The precoding indicator may indicate the subset of 2 out of the 3 antenna port indices to map the 2TX precoder. For example, a first precoding indicator may indicate a first (e.g., TPMI 1/sqrt(2)*[1 1]) and the index of ports 1 and 2, and a second precoding indicator may indicate a second (e.g., TPMI 1/sqrt(2)*[1 1]) with index of ports 1 and 3. The WTRU (e.g., UE) may apply the α and φ on the port indices determined by the precoding indicator.

According to embodiments, the WTRU (e.g., UE) may be scheduled for a (e.g., codebook-based PUSCH) transmission which includes a bit field for the precoding indicator in the grant. The WTRU (e.g., UE) may apply the determined precoder, power scaling, and co-phasing applied across the antenna port groups as a function of the precoding indicator.

According to embodiments, the WTRU (e.g., UE) may determine the precoders for transmission over 3TX antennas. Different antenna architecture may be considered, for example, where all antennas are co-polarized, or where an even number of antennas is cross-polarized with an additional antenna of either polarization.

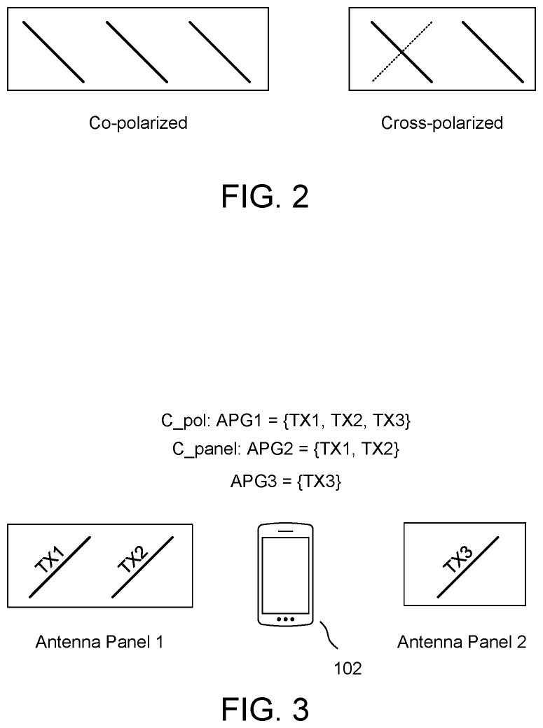

FIG. 2 illustrates these two different implementations where on the left the WTRU (e.g., UE) is equipped with 3 transmit antennas with the same polarization (plain line), and on the right the WTRU (e.g., UE) has 2 transmit antennas with the same polarization (plain line), and a third transmit antenna that is cross-polarized (dashed line). As example, herein, the case of 3 transmit antennas is discussed, but it may be generalized to a WTRU (e.g., UE) with any number of transmit antennas (e.g., odd number of transmit antennas or even number of transmit antennas, for example 2R+1 transmit antennas or 2R transmit antennas, wherein R is an integer value).

According to embodiments, the WTRU (e.g., UE) may send information indicating the antenna port group capabilities.

The WTRU (e.g., UE) may send a capability report which indicates it supports 3TX UL, and the WTRU (e.g., UE) indicates its antenna port groups. The antenna port group (APG) may comprise (e.g., consist of) a mapping of WTRU (e.g., UE) antennas to an antenna port group index (e.g., APG1). For a given capability, the WTRU (e.g., UE) may report: (1) a single antenna port group index mapped to all 3 TX antennas (e.g., APG1 with TX1, TX2, and TX3), or (2) two antenna port group indices where the first group maps to antenna 1 and 2 (e.g., APG1 with TX1, TX2) and the second group maps to antenna 3 (e.g., APG2 with TX3), or (3) three antenna port group indices where each group maps to a different antenna (e.g., APG1, APG2, and APG3 with TX1, TX2, and TX3, respectively).

The WTRU (e.g., UE) may determine which antennas map to which port group index according to the WTRU (e.g., UE) capabilities. Each mapping may be considered a capability group which is according to a capability criteria. The capability criteria may be used by the WTRU (e.g., UE) to indicate antennas which share the same capability within an APG. The WTRU (e.g., UE) may determine the index of the antennas in the same antenna port group according to any of the following criteria: (i) antennas with the same polarization; (ii) antennas co-located on the WTRU (e.g., UE) (e.g., front, side, back); (iii) antennas sharing the same power amplifier or oscillator; (iv) antennas on the same panel; (v) antennas with the same coherent state; and (vi) antennas with the same max transmit power (e.g., Pcmax).

For example, the WTRU (e.g., UE) may indicate antennas with the same polarization as part of a capability group for polarization, or antennas on the same panel as part of a capability group for panels. The WTRU (e.g., UE) may (e.g., alternatively) determine an arbitrary capability grouping of antennas to antenna port groups. The criteria for the grouping may be transparent to the network.

One or more (e.g., each) antenna may be part of multiple antenna port groups in different capability group. Within a capability group, the mapping of antenna to APGs is 1-to-1. The WTRU (e.g., UE) may report the parameters identifying the capability of the antennas in the port groups. The WTRU (e.g., UE) may report multiple port groups according to different capabilities.

For example, FIG. 3 illustrates a WTRU (e.g., UE) 102 with 2 panels and 3 co-polarized antennas. Panel 1 has 2 antennas, TX1 and TX2. Panel 2 has 1 antenna, TX3.

The WTRU (e.g., UE) identifies antenna port groups according to two different capabilities, antennas with same polarization and antennas on the same panel. The WTRU (e.g., UE) may report the antenna port groups (APGs) with C_pol and C_panel capability groups as [(C_pol: APG1={TX1, TX2, TX3}), (C_panel: APG2={TX1, TX2}, APG3={TX3})]. C_pol refers to the polarization capability group, so antennas TX1, TX2, and TX3 are co-polarized and are in the APG1 for polarization. C_panel refers to the panel capability group, so antennas TX1 and TX2 are located on the first panel in the same APG2, and TX3 is located on the second panel so it's in the APG3 for the second panel.

According to embodiments, the WTRU (e.g., UE) may receive an SRS configuration with SRS ports mapped to antenna port groups.

Based on the WTRU (e.g., UE) reported capability, the network may configure the WTRU (e.g., UE) with one or more 3-port SRS resources. The WTRU (e.g., UE) may receive information indicating the association between its antenna port groups and the SRS resources as part of the SRS resource configuration. The association may indicate which SRS resource and port is used for one or more (e.g., each) WTRU (e.g., UE) antenna port group. The WTRU (e.g., UE) may receive the association as part of the SRS RRC configuration. If there are multiple antenna port groups associated with different capability groups (e.g., such as the C_pol and C_panel), one of the capabilities is activated per SRS resource, and the associated port groups are mapped to the SRS ports. Different SRS resources may be associated with the different capabilities (e.g., a first SRS resource with C_pol, and a second SRS resource with C_panel). The WTRU (e.g., UE) may transmit over its 3 antennas with the antennas mapped to the port groups, and the port groups mapped to the SRS ports.

The network may receive the SRS and/or estimate the UL channel; it may determine the channel estimates per antenna port group. The network may use the channel estimates to determine which is the best precoder for the WTRU (e.g., UE). The network may perform a search through the preconfigured codebooks for 3TX to determine the precoding index and/or the number of layers, and/or may estimate channel conditions specific per APG. The network can detect, through the SRS, the impacts on different APGs. For example, the network may determine that the antennas in a first APG are received with a lower power compared to antennas in a second APG due to blocking. Blocking may impact more severely one antenna port group over another due to the positioning of the antennas on the device relative to the source of blockage (e.g., hand on the back of the device). The network may dynamically provide adjustments through the precoding indication.

In the following description, methods to indicate precoders for 3TX, and dynamically adjust the precoders per APG, are provided.

According to embodiments, the WTRU (e.g., UE) may receive information indicating codebook configurations with per antenna port group dynamic adjustment.

The precoders for 3TX may be RRC configured through a set of codebooks for 1, 2, and 3 layers. One or more (e.g., each) codebook may contain precoding matrices, one or more (e.g., each) of which is mapped to a TPMI. The WTRU (e.g., UE) may additionally receive a set of power scaling values (α={α1, . . . , αN}) and a set of co-phasing values (φ={φ1, . . . , φN}). The precoding indicator bit field in the grant may map to a TPMI, and/or may indicate an α and φ value from the set of values to apply per antenna port group. The network may use the α and φ value to provide adjustments per APG dynamically through the precoding indicator bit field.

Table 3 illustrates a precoding indicator bit field mapped to TPMI and adjustments per antenna port group. Table 3 shows one possible mapping of the bit field in the DCI to a TPMI and (α, φ) pair. For example, if the WTRU (e.g., UE) receives the bit field 0, then the WTRU (e.g., UE) transmits using the precoder with index TPMI=0 from the codebook of single layer precoders, and multiplies by αe^{φ} the complex factors from the precoding matrix entries associated to APG1. The TPMI=0 indicates the precoder

$$[ \begin{matrix}p 1 \\ p 2 \\ p 3\end{matrix} ] ,$$

and the APG1 consists of TX1 and TX2 (APG1={TX1, TX2}), then the WTRU (e.g., UE) determines the precoder of bit field 0 to be

$$[ \begin{matrix}α 1 {e}^{φ 1} * p 1 \\ α 1 {e}^{φ 1} * p 2 \\ p 3\end{matrix} ]$$

since the first two rows correspond to TX1 and TX2. If bit field 1 is indicated, the WTRU (e.g., UE) determines the precoder to be

$$[ \begin{matrix}p 1 \\ p 2 \\ α 2 {e}^{φ 2} p 3\end{matrix} ]$$

since the last row corresponds to APG2={TX3}.

TABLE 3

| Precoding | | | |
|---|---|---|---|
| indicator bit field | TPMI from 3TX | | |
| mapped to index | codebooks | α | φ |
| 0 | 1 layer: TPMI = 0 | α1 (APG1) | φ1 (APG1) |
| 1 | | α2 (APG2) | φ2 (APG2) |
| . . . | . . . | . . . | . . . |
| 4 | 2 layers: TPMI = 0 | α1 (APG1) | φ1 (APG1) |
| 5 | | α2 (APG2) | φ2 (APG2) |
| . . . | . . . | . . . | . . . |
| 10 | 3 layers: TPMI = 0 | α1 (APG1) | φ1 (APG1) |
| 11 | | α2 (APG2) | φ2 (APG2) |
| . . . | . . . | . . . | . . . |

In this example, the WTRU (e.g., UE) may report a single capability group with 2 APGs. Different WTRUs (e.g., UEs) may have different capability groups and different number of APGs.

According to embodiments, the network may configure a different table per WTRU (e.g., UE) according to each UE's reported capability groups and number of APGs. For example, the network may configure different tables for WTRUs (e.g., UEs) with a single APG, two APGs, or three APGs. Each WTRU (e.g., UE) may receive in the RRC a codebook subset restriction to indicate the index of the table. This allows the network to dynamically indicate the precoders with different adjustments per APG.

According to embodiments, the WTRU (e.g., UE) may be configured with multiple tables if the WTRU (e.g., UE) reports multiple capability groups. The grant may include an additional bit field to dynamically indicate which table the WTRU (e.g., UE) shall use to interpret the precoding bit field. For example, the WTRU (e.g., UE) may be configured with separate tables (e.g., Table 3) for two different capability groups (e.g., C_pol and C_panel). The WTRU (e.g., UE) may receive the precoding indicator bit field, and an additional capability group switching bit field to indicate the capability group mapping to the table (e.g., table for C_pol or table for C_panel). This may allow the network to dynamically indicate precoders for different capability groups with different adjustments per APG.

According to embodiments, the WTRU (e.g., UE) may also be configured with a single table if the WTRU (e.g., UE) reports multiple capability groups. The grant may include an additional bit field to dynamically indicate which capability group the WTRU (e.g., UE) shall use to interpret the precoding bit field. For example, the WTRU (e.g., UE) may be configured with one table (e.g., Table 3), and an additional capability group switching bit field to indicate the capability group mapping to the APGs. This may allow the network to dynamically indicate precoders for different capability groups with different adjustments per APG.

According to embodiments, the power scaling and co-phasing values may be separately indicated from the precoding indicator bit field. The grant may contain new separate bit fields for indicating one power scaling and co-phasing value from the set of values. The WTRU (e.g., UE) may receive an RRC configured table of power scaling and co-phasing value where each row is indexed with a bit field. The table may also indicate the APG associated per row. The WTRU (e.g., UE) may determine the precoder based on the precoding indicator bit field, and may determine the power scaling and co-phasing values per APG based on the new separate bit fields in the grant.

According to embodiments, the WTRU (e.g., UE) may be configured with multiple SRS resource sets, where each SRS resource set is associated to an APG. For example, a 2-port SRS resource may be configured in a first SRS resource set for the APG with 2 ports, and a 1-port SRS resource may be configured in a second SRS resource set for the APG with 1 port. The WTRU (e.g., UE) may receive a grant with an SRS resource set indicator bit field where each bit field maps to a different APG. The SRS resource set indicator may be used to indicate the APG where the power scaling and co-phasing values are applied. For example, with two bits, the SRS resource set bit field 00 indicates APG1, 01 indicates APG2, 10 indicates APG3, and 11 indicates no APG. The WTRU (e.g., UE) may receive power scaling and co-phasing values in a separate indication in the DCI. The WTRU (e.g., UE) may receive the precoding indicator field to determine the TPMI.

For example, if 00 is indicated, the WTRU (e.g., UE) may apply the power scaling and co-phasing values to the APG1 of the determined TPMI. For example, if 01 is indicated, the WTRU (e.g., UE) may apply the power scaling and co-phasing values to the APG2 of the determined TPMI. For example, if 10 is indicated, the WTRU (e.g., UE) may apply the power scaling and co-phasing values to the APG3 of the determined TPMI. For example, if 11 is indicated, the WTRU (e.g., UE) may determine the TPMI without applying the power scaling and co-phasing values to any APG.

According to embodiments, the WTRU (e.g., UE) may transmit (e.g., the PUSCH) with the determined 3TX precoder.

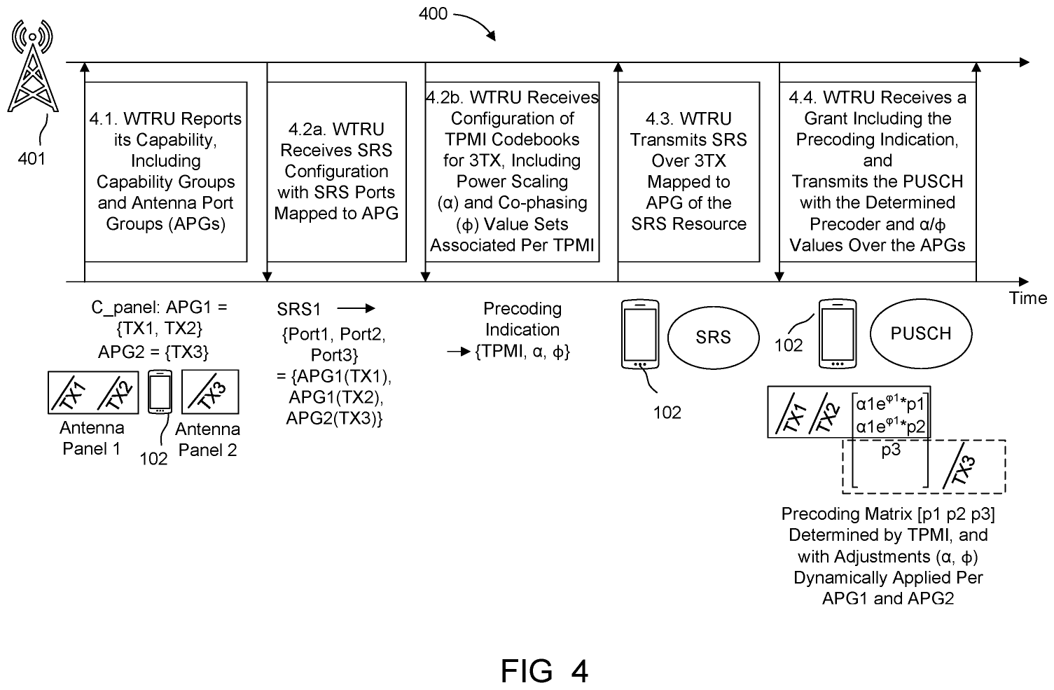

FIG. 4 illustrates a representative method/procedure 400 directed to precoding determination, for example for a WTRU comprising 3 transmit antennas.

In a step 4.1, the WTRU (e.g., UE) 102 may send information indicating (e.g., report) a single capability group, for example, C_panel, with two APGs. The information may be sent to a network 401. APG1 may contain a first transmit antenna TX1 and a second transmit antenna TX2, and APG2 may contain a third transmit antenna TX3.

In a step 4.2a, the WTRU (e.g., UE) 102 may receive, for example from the network 401, information indicating a configuration of reference signal (e.g., SRS or DMRS), for example, with an indication to transmit APG1 over port1 and port2 of the reference signal (e.g., SRS or DMRS) resource, and APG2 over port3 of the reference signal (e.g., SRS or DMRS) resource.

In a step 4.2b, the WTRU (e.g., UE) 102 may receive for example from the network 401, information indicating the precoding codebooks for 3TX with precoding indication configured to map to a TPMI from the codebooks, and an associated α and φ per TPMI.

In a step 4.3, the WTRU (e.g., UE) may transmit, for example to the network 401, the reference signal (e.g., SRS or DMRS), and the network may perform channel estimation to determine the precoder for the WTRU (e.g., UE).

In a step 4.4, the WTRU (e.g., UE) may be scheduled with a 3TX codebook-based (e.g., PUSCH) transmission. The WTRU (e.g., UE) may receive, for example from the network 401, information indicating the grant which include the precoding indicator bit field mapped to TPMI, and mapping of power scaling/co-phasing values to the WTRU (e.g., UE) APG. The WTRU (e.g., UE) may transmit uplink information (e.g., through the PUSCH) by applying the determined TPMI and power scaling/co-phasing values per APG to the symbols per layer. The WTRU (e.g., UE) may apply the same precoder over the ports used to transmit reference signals (e.g., DMRS ports) as well that are transmitted together with the uplink information (e.g., through the PUSCH). The reference signal (e.g., SRS or DMRS) may be used by the network to decode the precoded uplink information (e.g., through the PUSCH). The WTRU (e.g., UE) may apply the same mapping of APGs to the ports used to transmit reference signals (e.g., DMRS ports) that is indicated for the reference signal (e.g., SRS or DMRS) resource. For example, the grant may indicate to transmit the uplink information (e.g., through the PUSCH) with 3 ports used to transmit reference signals (e.g., DMRS ports). The WTRU (e.g., UE) may use APG1 with TX1 and TX2 to transmit, for example from the network 401, over the resources allocated for the first and second ports used to transmit reference signals (e.g., DMRS ports), and may use APG2 with TX3 to transmit over the resources allocated for the third port used to transmit reference signals (e.g., DMRS port).

According to embodiments, if the WTRU (e.g., UE) is configured with (e.g., receive information indicating) transmission (e.g., PUSCH) repetitions, the WTRU (e.g., UE) may transmit K repetitions of the (e.g., PUSCH) transport block or codeword. The WTRU (e.g., UE) may receive information indicating the number of repetitions, K, for example, through an RRC configured TDRA table which indicates the time domain resource allocation. According to embodiments, the WTRU (e.g., UE) may apply the same precoding indication to one or more (e.g., all the) repetitions (e.g., same TPMI and same (α, φ) for one or more (e.g., all) repetitions). According to embodiments, the WTRU (e.g., UE) may determine different TPMIs and/or (α, φ) values per APG per repetition. The WTRU (e.g., UE) may be configured with (e.g., receive information indicating) a cycling pattern of TPMIs and/or (α, φ) values over the repetitions.

According to embodiments, the same TPMI value may be applied over one or more (e.g., all) repetitions, and the WTRU (e.g., UE) may determine the (α, φ) per repetition based on a preconfigured pattern where one or more (e.g., each) repetition index is mapped to a (α, φ) value. The WTRU (e.g., UE) may be configured with (e.g., receive information indicating) (α, φ) value cycling to be on or off (e.g., RRC configured). One or more (e.g., each) repetition may map the determined (α, φ) values to the same APG.

According to embodiments, the cycling may be configured between the APGs associated to the (α, φ) values. For example, in a first repetition, the WTRU (e.g., UE) may apply the determined (α, φ) over APG1, and in a second repetition the WTRU (e.g., UE) may apply the determined (α, φ) over APG2.

According to embodiments, the precoding indicator bit field may be cycled as a function of the repetition index. One or more (e.g., each) repetition may be associated to a different precoding indicator bit field, so the WTRU (e.g., UE) may determine a separate TPMI and (α, φ) values per repetition index. The pattern of TPMIs may be preconfigured based on receiving a precoding indicator bit field that maps to multiple TPMIs and (α, φ). The WTRU (e.g., UE) may associate one or more (e.g., each) repetition index to one precoding indicator bit field in the pattern.

According to embodiments, if the WTRU (e.g., UE) reported multiple capabilities group, the capability group per repetition index may also be cycled. For example, in a first repetition, the WTRU (e.g., UE) may apply the precoding indication over the APGs of the panel capability group, and in a second repetition the WTRU (e.g., UE) may apply the precoding indication over the APGs of the polarization capability group.

According to embodiments, the WTRU (e.g., UE) may transmit the uplink information (e.g., through the PUSCH) repetitions with the determined TPMI and (α, φ) values per repetition index. According to embodiments, (e.g., instead of repetitions) the WTRU (e.g., UE) may transmit multiple transport blocks or codewords (e.g. multiple PUSCHs) in different time slots which are scheduled by a single grant. The same cycling pattern may apply over the transport blocks or codewords (e.g., instead of repetitions). The multiple transmissions may be transmitted towards different TRPs, for example, with different SRIs per repetition. The cycling of (α, φ) values may be associated with the cycling pattern of SRIs. For example, the WTRU (e.g., UE) may use a first pair of (α, φ) values if the uplink information (e.g., through the PUSCH) is transmitted with SRI1 towards TRP1, and uses a second pair of (α, φ) values if the uplink information (e.g., through the PUSCH) is transmitted with SRI2 towards TRP2.

Methods and apparatus for a fallback procedure to a lesser number of transmit antennas, are provided. For example, a fallback from 3Tx to 2TX.

In the previous sections, it may be assumed that the WTRU (e.g., UE) reports a capability of 3TX, and is configured with 3TX codebooks so the WTRU (e.g., UE) may always transmit on all 3TX (all APGs). Based on SRS measurements, the network may detect that the channel is (e.g., severely) degraded over some APGs, and may impact the performance of the 3TX transmission. The network may determine to fallback to 2TX transmission mode instead of 3TX. In fallback mode, the WTRU (e.g., UE) may transmit on a subset of antennas determined by the APGs. The network may (e.g., dynamically) send information indicating the APGs that the WTRU (e.g., UE) transmits on, and the APGs that the WTRU (e.g., UE) turns off. The WTRU (e.g., UE) may effectively transmit over 1 or 2 antennas in fallback mode (e.g., even if it reported a capability of 3TX).

According to embodiments, the WTRU (e.g., UE) may receive a (e.g., dynamic) indication (e.g., in a grant) to fallback to a codebook-based (e.g., PUSCH) transmission using 2TX TPMIs. The (e.g., dynamic) indication may be a bit field in the DCI to switch on/off one of more of the APGs. The WTRU (e.g., UE) may still receive a TPMI with 3TX, and may determine to transmit (e.g., only) on the antennas associated to the APGs that remain on. For example, a TPMI with 3TX may have APG1 mapped to the first two antennas, and APG2 mapped to the third antenna. If the WTRU (e.g., UE) receives an indication to turn off APG2, the WTRU (e.g., UE) may transmit the TPMI with the first two rows (e.g., corresponding to antenna 1 and 2 in APG1), and blanks the third row (e.g., corresponding to antenna 3 in APG2). If the WTRU (e.g., UE) determines that it is in the fallback mode, and the number of activated antennas is less than the number of configured antennas for the TPMI, the WTRU (e.g., UE) may re-scale its transmit power linearly over the APGs that are on. For example, with a TPMI for 3TX, the WTRU (e.g., UE) may split the power equally over the 3 antennas (e.g., P/3 per antenna). If the WTRU (e.g., UE) is in fallback mode, it may use the TPMI for 3TX with the third row blanked, and may split the power equally over the 2 antennas of the active APG (e.g., P/2 per antenna in APG1).

According to embodiments, the WTRU (e.g., UE) may fall back to 2TX port precoder instead of reusing 3TX port precoder with one row blanked. The precoding indicator from Table 3 becomes an RRC configured table that maps to TPMIs from the 3TX codebook, and to TPMIs from codebooks with different number of antennas than the WTRU (e.g., UE) reported capability (e.g., 2TX). If the WTRU (e.g., UE) reports a capability of 3TX, the WTRU (e.g., UE) may determine that it is in fallback mode whenever the precoder indication indicates a TPMI for 2TX.

If the WTRU (e.g., UE) reported a first APG with 2 antennas and a second APG with 1 antenna, the WTRU (e.g., UE) may fall back to the APG with 2 antennas. The WTRU (e.g., UE) may apply the determined 2TX TPMI over the antenna ports within the determined fallback APG. The WTRU (e.g., UE) may (e.g., additionally) receive α and φ factors, with an indication of the port indices within the antenna port group associated to the factors.

If the WTRU (e.g., UE) did not report an APG with 2TX (e.g., 1 APG with 3TX, or 3 APGs with 1TX each), the WTRU (e.g., UE) may (e.g., dynamically) determine the 2TX ports from the 3TX based on the precoding indicator. The WTRU (e.g., UE) may be configured with (e.g., receive information indicating) a fixed mapping from the 2TX TPMI rows to the WTRU (e.g., UE) antennas. For example, the WTRU (e.g., UE) may transmit the TPMI over the first and second WTRU (e.g., UE) antennas whenever fallback mode is detected/indicated. The WTRU (e.g., UE) may (e.g., additionally) receive α and φ factors, and the mapping to WTRU (e.g., UE) antenna port indices may follow the mapping of the TPMI to WTRU (e.g., UE) antenna ports.

According to embodiments, the WTRU (e.g., UE) may be configured with (e.g., receive information indicating) precoders for multilayer transmission. In the multilayer case, the precoding matrix (TPMI) for 3TX may have 3 rows (1 per antenna), and may have L columns, where L corresponds to the number of layers. One or more (e.g., each) column may be associated to a different APG. For example, a first APG may have 2TX, and a second APG may have 1TX. The precoding matrix may have two nonzero elements in the first column associated to the first APG, and one nonzero element in the second column associated to the second APG. The single layer case may be the fallback scenario where the WTRU (e.g., UE) is indicated to transmit with the first column of the precoding matrix. With more than one layer, the WTRU (e.g., UE) may receive a precoding indicator mapping to the TPMI using both columns. The first layer may be transmitted over the antennas in the APG1, and the second layer may be transmitted over the antenna in the APG2. The WTRU (e.g., UE) may be configured with the α and φ values. The WTRU (e.g., UE) may determine to apply the α and φ values as a function of the number of layers scheduled. For example, if the WTRU (e.g., UE) is scheduled with a single layer, then it is in fallback mode and the α and φ values are not applied. If the WTRU (e.g., UE) is scheduled with more than one layer, then the WTRU (e.g., UE) is in 3TX mode, and the α and φ are applied to the APG. The mapping of α and φ to the APG for 3TX may be indicated in the precoding indicator (e.g., in the RRC configured table such as Table 3).

A WTRU may indicate that it may support a hybrid codebook structure, where one level of coherency is supported for transmission using a first set of APGs, and another level of coherency on a second set of APGs. For example, a WTRU may perform coherent transmission using a first set of antennas, and non-coherent transmission using a second set of APGs. In another example, a WTRU with 2R+1 transmit antennas, may be configured with a codebook where depending on the coherence capability of a first 2R transmit antennas, the corresponding rows (columns) to 2R transmit antennas may be a coherent, partially coherent or a non-coherent precoders, while the corresponding row to the (2R+1)-th antenna may contain only phase shift elements, e.g., MPSK symbols, 8PSK, 4PSK, etc. According to embodiments, corresponding row to the (2R+1)-th antenna may be (e.g., additionally) scaled to adjust the power split among the antennas for a more accurate co-phasing. According to embodiments, in a case of a WTRU with 3 transmit antennas, for a 3-layer transmission, the WTRU may coherently combine the three layers for transmission over a first two transmit antennas, and it may co-phase the three layers by using phase adjusted combining for transmission on the 3^{rd} transmit antenna.

According to embodiments, if the WTRU (e.g., UE) detects a fallback indication, the WTRU (e.g., UE) may transmit the uplink information (e.g., through the PUSCH) with repetitions, where one or more (e.g., each) repetition uses a subset of the 3TX antennas (e.g., different APGs). For example, in the first repetition, the WTRU (e.g., UE) may transmit a 2TX TPMI over the first APG with antennas TX1 and TX2, and in the second repetition the WTRU (e.g., UE) may transmit over the second APG with only antenna TX3. The WTRU (e.g., UE) may determine the mapping of APG to repetitions based on a preconfigured rule that is applied whenever the WTRU (e.g., UE) is scheduled with repetitions and a fallback mode of operation.

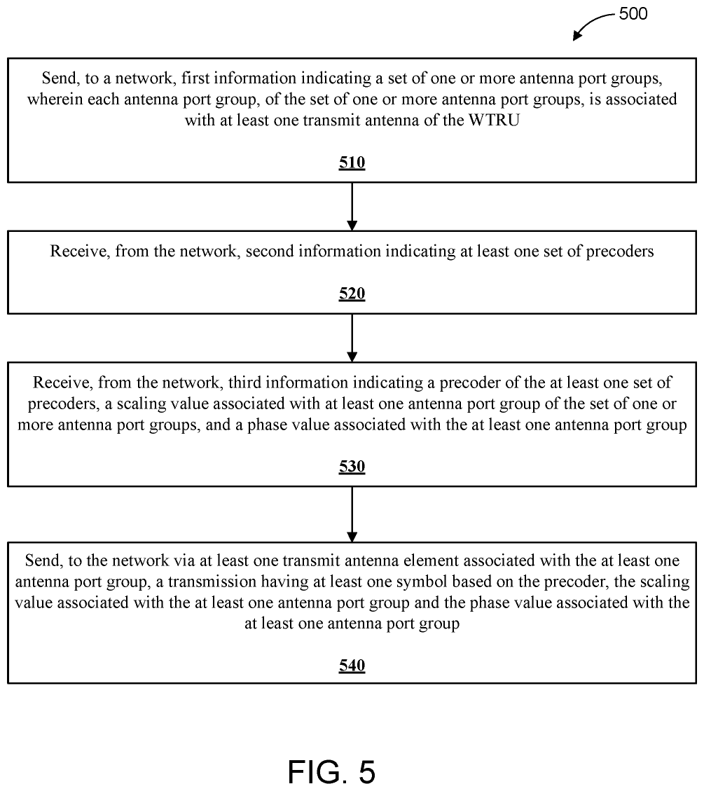

FIG. 5 is a flowchart illustrating a representative method 500 implemented by a WTRU 102.

Referring to FIG. 5, the representative method 500 may include, at block 510, sending, for example to a network, first information indicating a set of one or more antenna port groups, wherein one or more (e.g., each) antenna port group, of the set of one or more antenna port groups, may be associated with at least one transmit antenna of the WTRU.

At block 520, the representative method 500 may include receiving, for example from the network, second information indicating at least one set of precoders.

At block 530, the representative method 500 may include receiving, for example from the network, third information indicating a precoder of the at least one set of precoders, a (e.g., power) scaling value associated with at least one antenna port group of the set of one or more antenna port groups, and a (e.g., co-phasing) phase value associated with the at least one antenna port group.

At block 540, the representative method 500 may include sending, for example to the network via at least one transmit antenna (e.g., element) associated with the at least one antenna port group, a transmission (e.g., having at least one symbol) based on/according to/generated using the precoder, the scaling value associated with the at least one antenna port group and the phase value associated with the at least one antenna port group.

According to certain embodiments, the set of one or more antenna port groups, may comprise: (1) a first antenna port group associated with 3 transmit antennas of the WTRU; (2) a first antenna port group associated with 2 transmit antennas of the WTRU and a second antenna port group associated with 1 transmit antenna of the WTRU; or (3) a first antenna port group associated with 1 transmit antenna of the WTRU, a second antenna port group associated with 1 transmit antenna of the WTRU, and a third antenna port group associated with 1 transmit antenna of the WTRU.

According to certain embodiments, the representative method 500 may include any of the following steps: receiving, for example from the network, fourth information indicating at least one reference signal resource, wherein at least one reference signal resource may be associated with at least one transmit antenna (e.g., element) of the WTRU; sending, for example to the network, at least one reference signal via the least one transmit antenna of the WTRU. The precoder, for example indicated in the third information, may be based on a channel estimate of an uplink channel, and/or a channel estimate of the uplink channel may be based on at least one reference signal sent.

According to certain embodiments, the second information may indicate a first set of precoders for N transmit antennas, and/or a second set of precoders for M transmit antennas, and wherein M may be inferior to N.

According to certain embodiments, N=3, and/or M=2.

According to certain embodiments, N=2R+1, and M=2R, wherein R is an integer value.

According to certain embodiments, N=2R, and M=2R-1, wherein R is an integer value.

According to certain embodiments, on condition that the precoder indicated in the third information corresponds to a precoder of the second set of precoders, and/or on condition that the set of one or more antenna port groups comprises a first antenna port group associated with M transmit antennas, the method 500 may further comprise: sending, for example to the network, the transmission via at least one transmit antenna (e.g., element) of the first antenna port group, using the precoder, a power scaling value associated with the first antenna port group and/or a co-phasing value associated with the first antenna port group.

According to certain embodiments, on condition that the precoder indicated in the third information corresponds to a precoder of the second set of precoders, and/or on condition that the set of one or more antenna port groups does not comprise (e.g., lacks) an antenna port group associated with M transmit antennas, the method 500 may further comprise any of the following steps: determining a subset of M transmit antennas from the N transmit antennas; determining based on the subset of M transmit antennas and based on the third information, a power scaling value associated with the subset, and/or a co-phasing value associated with the subset; and sending, for example to the network, the transmission via at least one transmit antenna (e.g., element) associated with the subset, using the precoder, the power scaling value associated with the subset and/or the co-phasing value associated with the subset.

According to certain embodiments, the representative method 500 may include any of the following steps: receiving, for example from the network, fifth information comprising a number L of transmission repetition; and/or sending, for example to the network, L transmission via the at least one transmit antenna (e.g., element) of the at least one antenna port group, using the precoder, the power scaling value associated with the at least one antenna port group and/or the co-phasing value associated with the at least one antenna port group.

According to certain embodiments, the third information may indicate a scheduling of the transmission.

According to certain embodiments, a plurality of transmit antennas of the at least one antenna port group may comprise any of: a same polarization, a same location at the WTRU, a same panel, and a same coherent state.

According to certain embodiments, one or more (e.g., each) antenna port groups of the set of one or more antenna port groups is associated with a disjoint subset of transmit antennas of the WTRU.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

### REFERENCES

The following references are incorporated herein by reference in their entireties.
[1] “New WID: NR MIMO Phase 5”, 3GPP Tdoc RP-234007, 3GPP TSG RAN Meeting #102, December 2023
[2] 3rd Generation Partnership Project; Technical Specification Group Radio Access Network; NR; Multiplexing and channel coding; (Release 18); 3GPP TS 38.212 V18.1.0, (2023-12)
[3] 3rd Generation Partnership Project; Technical Specification Group Radio Access Network; NR; Physical channels and modulation; (Release 18); 3GPP TS 38.211 v18.1.0, (2023-12)

What is claimed is:

1. A method implemented in a wireless transmit/receive unit (WTRU), the method comprising:
sending, to a network, first information indicating a set of one or more antenna port groups, wherein each antenna port group, of the set of one or more antenna port groups, is associated with at least one transmit antenna of the WTRU;
receiving, from the network, second information indicating at least one set of precoders;
receiving, from the network, third information indicating a precoder of the at least one set of precoders, a scaling value associated with at least one antenna port group of the set of one or more antenna port groups, and a phase value associated with the at least one antenna port group; and
sending, to the network via at least one transmit antenna element associated with the at least one antenna port group, a transmission having at least one symbol based on the precoder, the scaling value associated with the at least one antenna port group and the phase value associated with the at least one antenna port group.

2. The method according to claim 1, wherein the set of one or more antenna port groups, comprises: (1) a first antenna port group associated with 3 transmit antennas of the WTRU; (2) a first antenna port group associated with 2 transmit antennas of the WTRU and a second antenna port group associated with 1 transmit antenna of the WTRU; or (3) a first antenna port group associated with 1 transmit antenna of the WTRU, a second antenna port group associated with 1 transmit antenna of the WTRU, and a third antenna port group associated with 1 transmit antenna of the WTRU.

3. The method according to claim 1, further comprising:
receiving, from the network, fourth information indicating at least one reference signal resource, wherein at least one reference signal resource is associated with at least one transmit antenna of the WTRU; and
sending, to the network, at least one reference signal via the least one transmit antenna of the WTRU, wherein the precoder is based on a channel estimate of an uplink channel, and wherein a channel estimate of the uplink channel is based on the at least one reference signal.

4. The method according to claim 1, wherein the second information indicates a first set of precoders for N transmit antennas, and wherein a second set of precoders for M transmit antennas, and wherein M is inferior to N.

5. The method according to claim 4, wherein on condition that the precoder corresponds to one of the second set of precoders, and on condition that the set of one or more antenna port groups comprises a first antenna port group associated with M transmit antennas, the method further comprises:
sending, to the network, the transmission via at least one transmit antenna element associated with the first antenna port group, using the precoder, a scaling value associated with the first antenna port group and a phase value associated with the first antenna port group.

6. The method according to claim 4, wherein on condition that the precoder corresponds to one of the second set of precoders, and on condition that the set of one or more antenna port groups lacks an antenna port group associated with M transmit antennas, the method further comprises:
determining a subset of M transmit antennas from the N transmit antennas;
determining, based on the subset of M transmit antennas and based on the third information, a scaling value associated with the subset and a phase value associated with the subset; and
sending, to the network, the transmission via at least one transmit antenna element associated with the subset, using the precoder, the scaling value associated with the subset and the phase value associated with the subset.

7. The method according to claim 1, further comprising:
receiving, from the network, fifth information comprising a number L of transmission repetition; and
sending, to the network, L transmission via the at least one transmit antenna element associated with the at least one antenna port group, using the precoder, the scaling value associated with the at least one antenna port group and the phase value associated with the at least one antenna port group.

8. The method according to claim 1, wherein the third information indicates a scheduling of the transmission.

9. The method according to claim 1, wherein a plurality of transmit antennas of the at least one antenna port group comprises any of: a same polarization, a same location at the WTRU, a same panel, and a same coherent state.

10. The method according to claim 1, wherein each antenna port groups of the set of one or more antenna port groups is associated with a disjoint subset of transmit antennas of the WTRU.

11. A wireless transmit/receive unit (WTRU) comprising: a processor and a transmit/receive unit configured to:
send, to a network, first information indicating a set of one or more antenna port groups, wherein each antenna port group, of the set of one or more antenna port groups, is associated with at least one transmit antenna of the WTRU;
receive, from the network, second information indicating at least one set of precoders;
receive, from the network, third information indicating a precoder of the at least one set of precoders, a power value associated with at least one antenna port group of the set of one or more antenna port groups, and a phase value associated with the at least one antenna port group; and
send, to the network via at least one transmit antenna element associated with the at least one antenna port group, a transmission having at least one symbol based on the precoder, the scaling value associated with the at least one antenna port group and the phase value associated with the at least one antenna port group.

12. The WTRU according to claim 11, wherein the set of one or more antenna port groups, comprises: (1) a first antenna port group associated with 3 transmit antennas of the WTRU; (2) a first antenna port group associated with 2 transmit antennas of the WTRU and a second antenna port group associated with 1 transmit antenna of the WTRU; or (3) a first antenna port group associated with 1 transmit antenna of the WTRU, a second antenna port group associated with 1 transmit antenna of the WTRU, and a third antenna port group associated with 1 transmit antenna of the WTRU.

13. The WTRU according to claim 11, wherein the processor and the transmit/receive unit configured are further configured to:
receive, from the network, fourth information indicating at least one reference signal resource, wherein at least one reference signal resource is associated with at least one transmit antenna of the WTRU; and
send, to the network, at least one reference signal via the least one transmit antenna of the WTRU,
wherein the precoder is based on a channel estimate of an uplink channel, and wherein a channel estimate of the uplink channel is based on the at least one reference signal.

14. The WTRU according to claim 11, wherein the second information indicates a first set of precoders for N transmit antennas, and wherein a second set of precoders for M transmit antennas, and wherein M is inferior to N.

15. The WTRU according to claim 14, wherein on condition that the precoder corresponds to one of the second set of precoders, and on condition that the set of one or more antenna port groups comprises a first antenna port group associated with M transmit antennas, the processor and the transmit/receive unit are further configured to:
send, to the network, the transmission via at least one transmit antenna element associated with the first antenna port group, using the precoder, a scaling value associated with the first antenna port group and a phase value associated with the first antenna port group.

16. The WTRU according to claim 14, wherein on condition that the precoder corresponds to one of the second set of precoders, and on condition that the set of one or more antenna port groups lacks an antenna port group associated with M transmit antennas, the processor and the transmit/receive unit configured are further configured to:
determine a subset of M transmit antennas from the N transmit antennas;
determine based on the subset of M transmit antennas and based on the third information, a scaling value associated with the subset, and a phase value associated with the subset; and
send, to the network, the transmission via at least one transmit antenna element associated with the subset, using the precoder, the scaling value associated with the subset and the phase value associated with the subset.

17. The WTRU according to claim 11, wherein the processor and the transmit/receive unit are further configured to:
receive, from the network, fifth information comprising a number L of transmission repetition; and
send, to the network, L transmission via the at least one transmit antenna element associated with the at least one antenna port group, using the precoder, the scaling value associated with the at least one antenna port group and the phase value associated with the at least one antenna port group.

18. The WTRU according to claim 11, wherein the third information indicates a scheduling of the transmission.

19. The WTRU according to claim 11, wherein a plurality of transmit antennas of the at least one antenna port group comprises any of: a same polarization, a same location at the WTRU, a same panel, and a same coherent state.

20. The WTRU according to claim 11, wherein each antenna port group of the set of one or more antenna port groups is associated with a disjoint subset of transmit antennas of the WTRU.
